(19) United States
(12) Patent Application Publication
(10) Pub. No.: US 2008/0144863 A1
(43) Pub. Date: Jun. 19, 2008

(54) Microcap packaging of micromachined acoustic devices

(76) Inventors: R. Shane Fazzio, Loveland, CO (US); Kristina L. Lamers, Fort Collins, CO (US)

Correspondence Address: Kathy Manke;Avago Technologies Limited, 4380 Ziegler Road, Fort Collins, CO, 80525, US

(21) Appl. No.: 11/640,051

(22) Filed: Dec. 15, 2006

(51) Int. Cl. H04R 17/00

(52) U.S. Cl. 381/190

(57) ABSTRACT

Transducer structures and methods of manufacture are described.

### BACKGROUND

Transducers (e.g., microphones (mics) and speakers) are provided in a wide variety of electronic applications. As the need to reduce the size of many components continues, the demand for reduced-size transducers continues to increase as well. This has lead to comparatively small transducers, which may be micromachined according to technologies used in the fabrication of micro-electromechanical systems (MEMS).

One type of transducer is a micromachined piezoelectric transducer. The piezoelectric transducer includes a layer of piezoelectric material between two conductive plates (electrodes). An acoustic wave incident on the membrane of a piezoelectric mic results in the application of a time varying force to the piezoelectric material. Application of this force to a piezoelectric material results in induced stresses in the piezoelectric material, which in-turn creates a time-varying voltage signal across the material. This time-varying voltage signal may be measured by sensor circuits to determine the characteristics of the incident acoustic wave. Alternatively, this time-varying voltage signal may produce a time-varying charge that is provided to sensor circuits that process the signal and determine the characteristics of the incident acoustic wave. As will be appreciated, the application of a time-varying electric driver signal to a piezoelectric speaker, by contrast, will result in a time varying acoustic signal.

While micromachined transducers have garnered significant attention, manufacturing and packaging of the devices has remained comparatively labor-intensive and costly.

There is a need, therefore, to overcome at least the shortcomings described above.

### SUMMARY

In accordance with an illustrative embodiment, a transducer structure includes: a substrate having an upper surface and a lower surface; a piezoelectric transducer disposed over the upper surface and over a cavity in the substrate; a microcap structure having a gasket, which contacts the upper surface of the substrate; and an opening adapted to provide ambient pressure equalization, or directional acoustic reception or transmission to the transducer.

In accordance with another illustrative embodiment, a method of fabricating a transducer includes: providing a substrate; etching a cavity in the substrate; disposing a transducer over the cavity; providing a microcap over the substrate; and forming an opening adapted to provide ambient pressure equalization, or directional acoustic reception or transmission to the transducer.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

Fig. is a cross-sectional view of a transducer structure in accordance with a representative embodiment.

FIGS. 2A-2D are cross-sectional views of a method of fabricating a transducer structure in accordance with a representative embodiment.

FIG. 3 is a cross-sectional view of a transducer structure in accordance with a representative embodiment.

FIG. 4 is a cross-sectional view of a transducer structure in accordance with a representative embodiment.

FIGS. 5A-5C are top views of transducer structures in accordance with representative embodiments.

FIG. 6 is a cross-sectional view of a transducer structure in accordance with another representative embodiment.

FIGS. 7A-7B are cross-sectional views of a transducer structure in accordance with a representative embodiment.

### DEFINED TERMINOLOGY

The terms ‘a’ or ‘an’, as used herein are defined as one or more than one.

The term ‘plurality’ as used herein is defined as two or more than two.

The term ‘direction’ as used herein is defined as from a particular direction (e.g., along an axis), or from a side of a transducer (e.g., from a general direction), or both.

### DETAILED DESCRIPTION

In the following detailed description, for purposes of explanation and not limitation, specific details are set forth in order to provide a thorough understanding of example embodiments according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of hardware, software, firmware, materials and methods may be omitted so as to avoid obscuring the description of the illustrative embodiments. Nonetheless, such hardware, software, firmware, materials and methods that are within the purview of one of ordinary skill in the art may be used in accordance with the illustrative embodiments. Such hardware, software, firmware, materials and methods are clearly within the scope of the present teachings.

While the present description is drawn primarily to microphones, the present teachings contemplate applications to transducers in general. For example, as one of ordinary skill in the art will readily appreciate, the present teachings may be applied to piezoelectric speakers.

The piezoelectric mics of the representative embodiments are contemplated for use in a variety of electronic devices. A representative electronic device may be a portable device such as a mobile phone, a camera, a video camera, a personal digital assistant (PDA), a sound recording device, a laptop computer, a tablet computer, a handheld computer, a handheld remote, or an electronic device that comprises the functionality of one or more of these devices. It is emphasized that the noted devices are merely illustrative and that other devices are contemplated. In some representative embodiments, the electronic device is a device that benefits from a microphone structure having a plurality of microphones, with at least one microphone optionally being adapted to function in more than one mode.

In many representative embodiments, the electronic devices are portable. However, this is not essential. In particular, the microphone structures of the present teachings are also contemplated for use in devices/apparatuses that are substantially stationary; and in devices/apparatuses that are mobile, but in which the microphone structures remain substantially stationary. For example, the microphone structures of representative embodiments may be used in industrial machinery applications, motor vehicle applications, aircraft applications, and watercraft applications, to name only a few.

FIG. 1 is a cross-sectional view of a mic structure 100 in accordance with an illustrative embodiment. The mic structure 100 includes a substrate 101 with a piezoelectric mic 102 disposed over a vent or cavity 103. The piezoelectric mic 102 includes electrodes and at least one layer of piezoelectric material (e.g., AlN) and may be as described in co-pending U.S. patent applications to R. Shane Fazzio, et al.: “Transducers with Annular Contacts,” having serial number (ADD) and filing date (ADD); and “Piezoelectric Microphones,” having serial number (ADD) and filing date Oct. 27, 2006. The disclosures of these applications are specifically incorporated herein by reference. Alternatively, the piezoelectric mic may be a transducer based on another technology, such as a capacitive mic.

A microcap structure 104 is disposed over the substrate and encloses the mic 102 as shown. The microcap structure 104 includes a gasket 105 that is adhered to an upper surface of the substrate 101 by an adhesive material 106 (e.g., gold) as shown. Many aspects of ‘microcapping’ are known and are described, for example in the following representative U.S. Pat. Nos. 6,265,246; 6,376,280; 6,429,511; 6,777,267; 6,787,897; and 6,979,597 all to Ruby, et al.; and U.S. Pat. No. 6,777,263, to Gan, et al. The disclosures of these patents are specifically incorporated herein by reference. Furthermore, the microcapping may be as described in commonly assigned and co-pending U.S. patent application Ser. No. 11/540,412 entitled “PROTECTIVE STRUCTURES AND METHODS OF FABRICATING PROTECTIVE STRUCTURES OVER WAFERS” to Frank S. Geefay, et al. This application, filed Sep. 28, 2006, is specifically incorporated herein by reference.

The mic structure 100 also includes a vent opening 107, illustratively provided in the microcap structure 104. As described more fully herein, the opening 107 may be useful in providing directionality to the mic structure 101, or ambient pressure equalization, or both.

Illustratively, the microcap structure 104 is a semiconductor material (e.g., silicon) or other material readily adapted to large scale processing. Alternatively, the microcap structure 104 may be a polymer material, such as described in the referenced application to Geefay, et al.

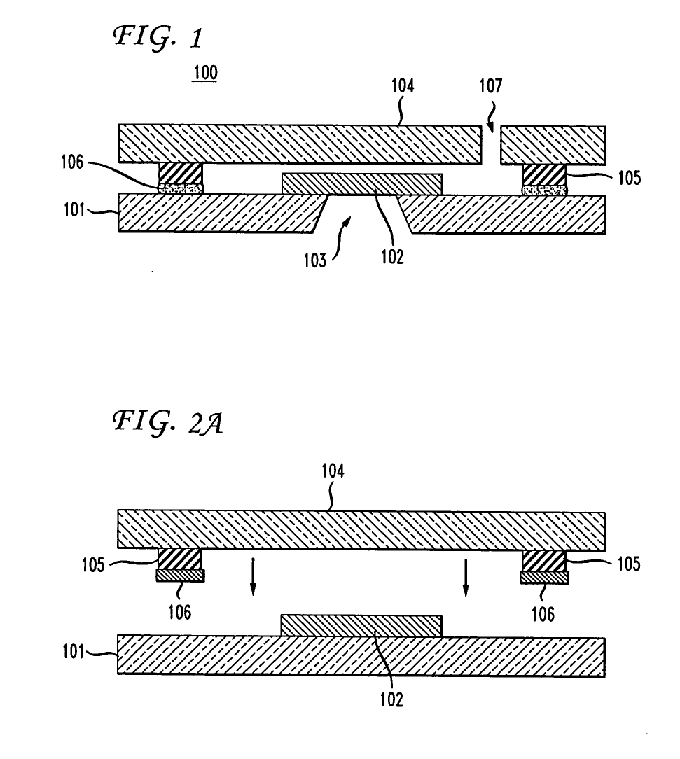

FIGS. 2A-2D are cross-sectional views of a fabrication sequence resulting in a mic structure in accordance with a representative embodiment.

FIG. 2A shows the alignment of the microcap 104 over the substrate 101. An adhesive material 106 may be patterned over the gasket 105 to bond the gasket 105 to the substrate 101 by thermocompression bonding or other suitable method such as described in the incorporated patents and patent application.

FIG. 2B shows the microcap 104 bonded to the substrate 101 with the cavity 103 formed beneath the mic 102. As described in the application “Piezoelectric Microphones,” the removal of a portion of the substrate 101 to provide the cavity 103 results in vibration of the membrane of the mic 102 from audio signals.

The cavity 103 may be formed by one of a variety of known dry or wet etching methods. For example, the cavity may be formed by a deep reactive ion etching (DRIE) such as the Bosch Method. Alternatively, the cavity 103 may be formed using a wet etchant with sufficient etch selectivity such as potassium hydroxide (KOH) or tetra-methyl ammonium hydroxide (TMAH).

In certain representative embodiments, the mic 102 may be a cantilevered piezoelectric structure such as described in U.S. Pat. No. 6,384,697 entitled “Cavity Spanning Bottom Electrode of Substrate Mounted Bulk Wave Acoustic Resonator” to Ruby, et al. and assigned to the present assignee. The disclosure of this patent is specifically incorporated herein by reference. Among other benefits, the cantilevered structure provides a vent useful in pressure equalization to the ambient pressure, and without the need for an opening (e.g., opening 107) in the microcap 104.

In a particular embodiment that includes a cantilever structure, the fabrication of the vent 103 may be carried out by providing a sacrificial layer (e.g., phospho-silicate glass (PSG), not shown) in a cavity (not shown) etched from the substrate 101. A polishing step, such as chemical mechanical polishing (CMP) may be used to provide a flush surface of the sacrificial layer with the substrate 101. The components of the mic 102 may then be formed over the sacrificial layer and an upper surface 108 of the substrate. The sacrificial layer may then be used as an etch-stop layer in an etch step (e.g., DRIE) from a lower surface 109. After the etching sequence is complete, release/removal of the sacrificial layer may be carried out. As the details of the noted cantilevered structure and fabrication sequence are known, certain details are omitted to avoid obscuring the description of the representative embodiments.

Optionally, the thickness of the substrate 101, or the thickness of the microcap 104, or both may be reduced to provide a comparably smaller package. Moreover, reducing the thickness of the substrate 101 may provide improved performance by reducing energy loss, particularly in high frequency applications. Notably, and as will be appreciated by one of ordinary skill in the art, supporting circuitry (not shown in FIG. 2C) may benefit from the reduction in losses by thinning the substrate 101.

In a representative embodiment, the substrate 101 may be thinned by a coarse grinding step using a diamond grinder or similar device. After completion of the coarse grinding step, an optional polishing step is carried out to provide an acceptably smooth lower surface to the substrate 101. The polishing step may be carried out by a known method, such as chemical mechanical polishing (CMP).

The microcap structure 104 substantially seals the components (e.g., the mic 102) and thus beneficially provides protection to the components disposed over the substrate 101 during the substrate thinning sequence. Moreover, the microcap structure 104 provides mechanical support to the structure 100 during the thinning sequence. After the thinning of the substrate 101 is completed, the microcap 104 may be thinned by a similar method.

As shown in FIG. 2C, after completion of the optional thinning of the substrate 101 of microcap 104, or both, an opening 201 is provided through the microcap 104. The opening 201 is substantially the same as opening 107, but is located in an aligned manner with the cavity 103. The opening 201 may be fabricated by a dry or wet etching technique known to those skilled in the art.

The opening 201 usefully provides pressure equalization with the ambient pressure, and directionality for the mic 102. With regard to the latter, in certain embodiments, the mic structure 100 may be disposed over a substrate (not shown) with the lower surface 109 of substrate 101 in contact with the substrate.

Connections to the mic 102 and supporting circuitry may be made by vias, or wirebonds, or other known electrical connections, or a combination thereof. In an embodiment in which the substrate 101 is disposed over another substrate, the backside of the mic 102 is substantially acoustically isolated from sound waves from a direction 202; and the opening 201 provides a conduit for sound waves emanating from a direction 203. Notably, pressure equalization may be provided by another opening (not shown in FIG. 2C) in the gasket 105 or the microcap 104, for example.

In accordance with representative embodiments, the process sequence of FIGS. 2A-2C is usefully carried out in wafer-scale processing. Thus, a comparably large number of mic structures 100 may be fabricated from a single wafer, with microcapping being carried out over the wafer. After the processing is completed, the wafer may be singulated by known methods to provide individual mic structures 100 in large quantity. Notably, the singulation may be performed comparably close to the gasket 105 enabling the length and width of the structure 100 to be on the order of approximately 200 μm to approximately 3.0 mm. Moreover, and as noted, the thinning of the substrate 101, or the microcap 104, or both results in a reduced height of the structure 100 as noted above. As will be appreciated, according to the present teachings, large quantities of mic structures 100 may be fabricated in comparably small dimensions. The former may usefully reduce the cost, and the latter may provide disparate implementations of the mic structure 100.

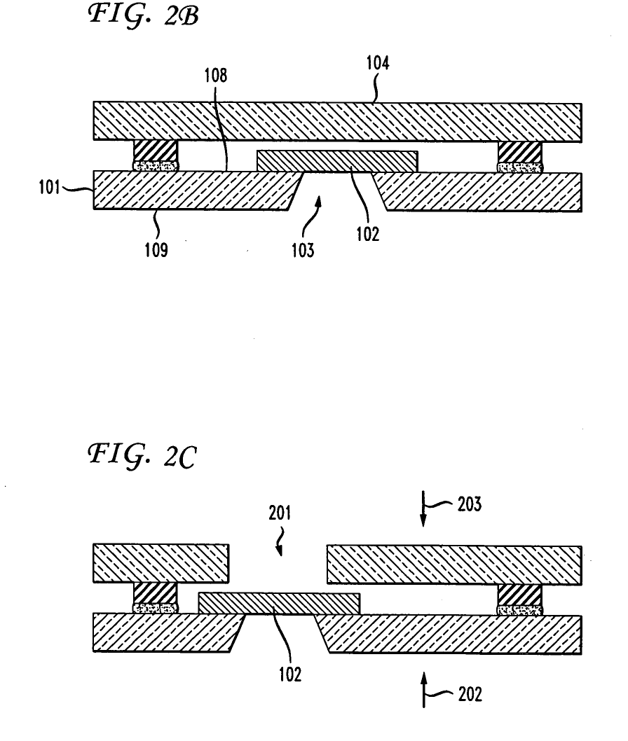

FIG. 3 is a cross-sectional view of a mic structure 300 in accordance with another representative embodiment. Many of the details of the mic structure are common with those described in connection with the representative embodiments of FIGS. 1-2C and are not repeated so as to avoid obscuring the description of the present embodiment.

As noted previously, in order to provide pressure equalization with the ambient pressure, an opening is often provided. In embodiments described above, this opening is provided in the microcap 104, or in the substrate 101, or via the cantilever structure if the mic 102. However, in the present embodiment, an opening 301 is provided in the mic structure 102 to provide the pressure equalization. Illustratively, the opening is fabricated by known etching methods.

Among other benefits, by providing the opening 301 through the mic structure 102, directional acoustic reception may be provided from direction 303 and acoustic isolation may be provided from sound waves emanating from direction 304.

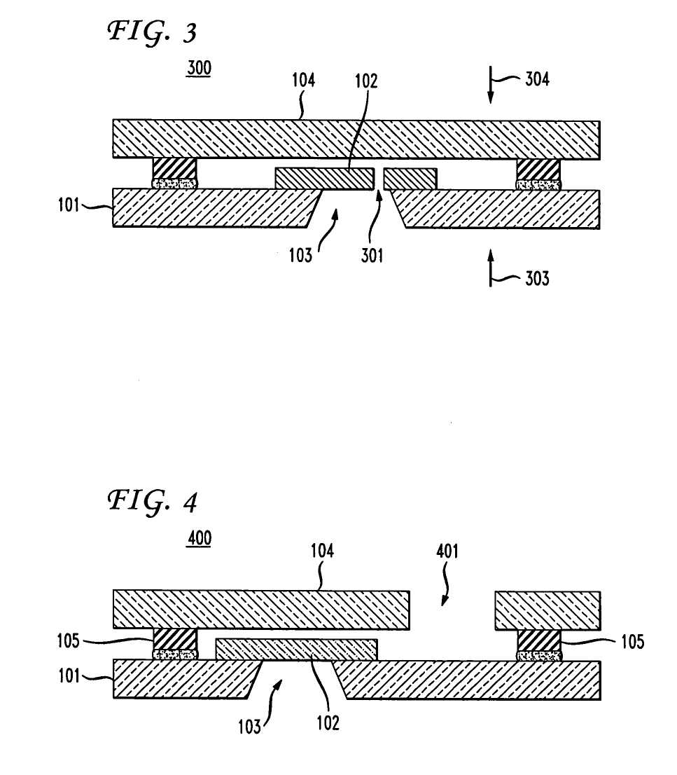

FIG. 4 is a cross-sectional view of a mic structure 400 in accordance with a representative embodiment. Many of the details of the mic structure are common with those described in connection with the representative embodiments of FIGS. 1-3 and are not repeated so as to avoid obscuring the description of the present embodiment.

The mic structure 400 includes opening 401 that is offset relative to the mic 102. The opening may be used in pressure equalization with the ambient pressure or to provide directionality to the mic structure. Notably, by selecting the amount of offset of the opening 401 and the dimensions of the opening 401, the properties of an acoustic cavity formed between the mic 102 and the microcap 104 can be varied.

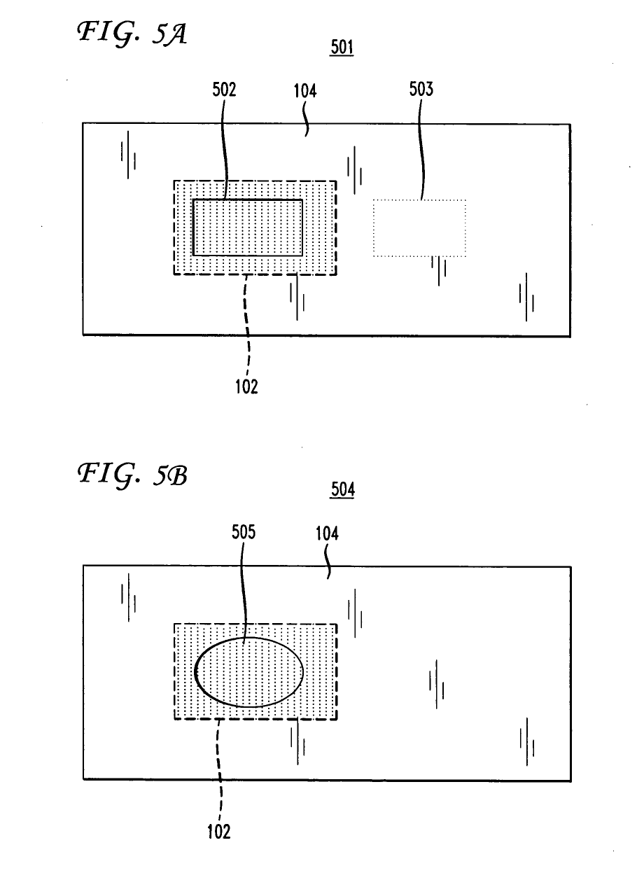

FIGS. 5A-5C are top views of mic structures in accordance with representative embodiments. Many of the details of the presently described mic structures are common with those described in connection with the representative embodiments of FIGS. 1-4 and are not repeated so as to avoid obscuring the description of the present embodiment.

FIG. 5A shows a mic structure 501 having an opening 502 disposed over the mic 102 (shown with dotted line shading). The opening 502 is formed in the microcap 104 and is of a substantially rectangular shape. Alternatively, an opening 503 may be formed offset relative to the mic 102.

FIG. 5B shows a mic structure 504 having an opening 505 disposed over the mic 102 (shown with dotted line shading). The opening 505 is formed in the microcap 104 and is of a substantially circular shape.

FIG. 5C shows a mic structure 506 in accordance with yet another representative embodiment. In the present embodiment, a conduit 507 is provided in the microcap 104 and is acoustically coupled to the mic 102 and an opening 508. This structure may improve the coupling of the mic 102 with the ambient. Moreover, this structure allows for indirect coupling of the mic 102 to the ambient. Notably, the shape of the opening 508 is merely illustrative. In fact, other shapes, such as rectangular shaped openings are contemplated.

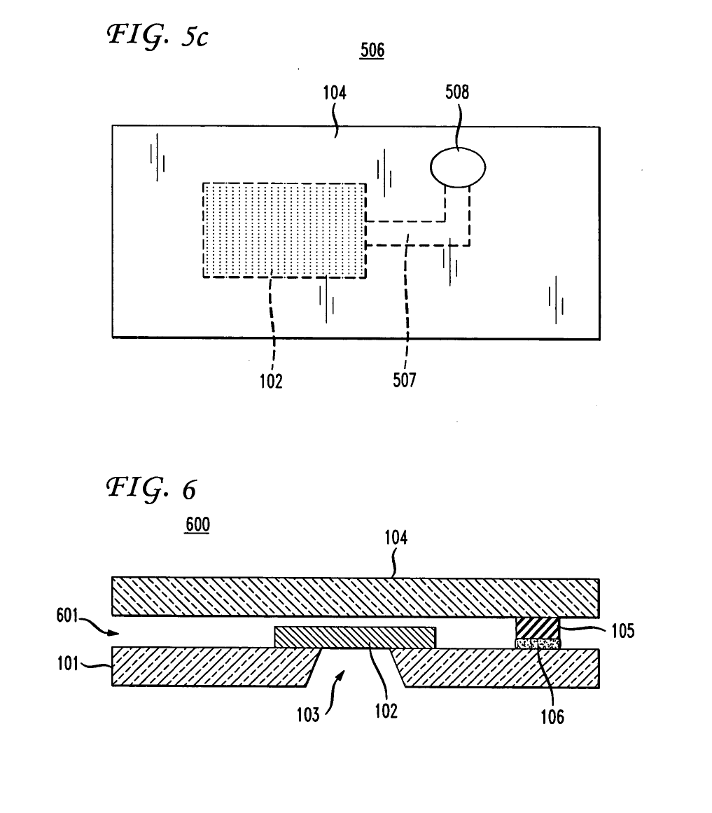

FIG. 6 is a cross-sectional view of a mic structure 600 in accordance with another representative embodiment. Many of the details of the presently described mic structures are common with those described in connection with the representative embodiments of FIGS. 1-5C and are not repeated so as to avoid obscuring the description of the present embodiment.

In the present embodiment, a portion of the gasket 105 and adhesive material 106 are not provided. This allows for an opening 601 to provide either directional acoustic reception from a side of the mic 600, or ambient pressure equalization, as desired. As will be appreciated, the gasket 105 is annular about the mic structure 600. As such, the opening 601 may be made therein as shown without compromising the structural integrity of the microcap 104 over the substrate 101.

In representative embodiments, the opening 601 may be provided by etching the gasket 105 and adhesive material 106. Alternatively, the opening 601 may be formed during patterning of the adhesive material 106 on the gasket 105, by providing a region where the adhesive material 106 is not provided, or by etching the adhesive material 106 in the desired region before bonding the gasket 105 to the substrate 101. Moreover, the opening 601 may be formed by patterning a gap in a portion of the gasket 105 in the desired region.

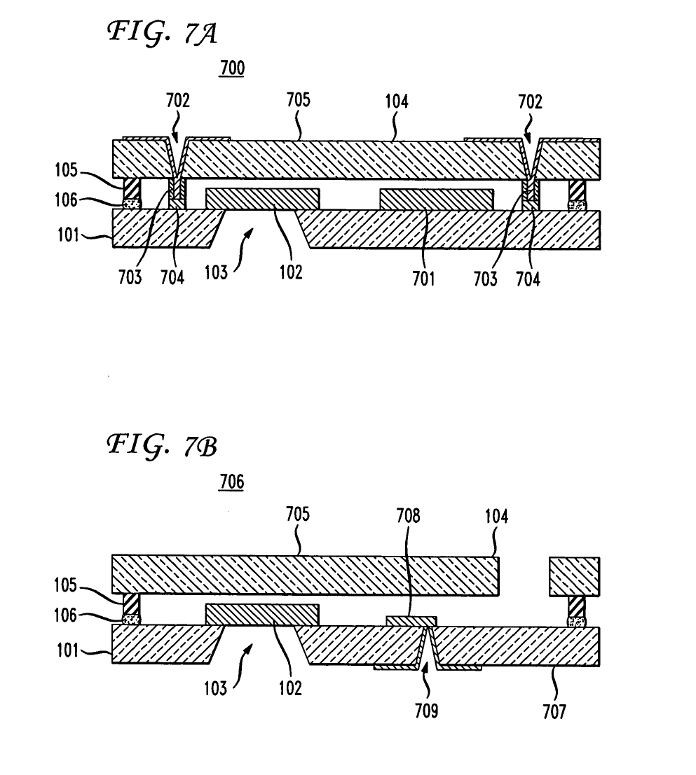

FIG. 7A is a cross-sectional view of a mic structure 700 in accordance with another representative embodiment. Many of the details of the presently described mic structures are common with those described in connection with the representative embodiments of FIGS. 1-6 and are not repeated so as to avoid obscuring the description of the present embodiment.

The structure 700 of the present embodiment includes a component 701 disposed over the substrate 101. The component 701 may be an amplifier circuit or signal processing circuit that supports the mic 102. Illustratively, the component 701 may be a CMOS circuit in chip form, or may be an application specific integrated circuit (ASIC). It is emphasized that the noted circuits and their instantiation are merely illustrative; and that other circuits are contemplated. Moreover, while only one component 701 is shown and described, it is emphasized that more than one component is contemplated.

In another representative embodiment, the component 701 is foregone, and circuitry such noted above in connection with the component 701 may be provided in the microcap. For example, as noted above, the microcap 104 may be fabricated in a semiconductor material such as silicon. As such, circuitry adapted to support the mic 102 may be instantiated in the microcap 104. Moreover, circuitry that is not in support of the mic 102 may be instantiated in the microcap 104 as well. Further details of the a microcap layer to include circuitry may be found in U.S. patent Publication 2006/0128058 A1 entitled “Wafer Bonding of Micro-Electromechanical Systems to Active Circuitry” to and U.S. patent Publication 2006/0125084 entitled “Integration of Micro-Electromechanical Systems and Active Circuitry” both to Dungan, et al. and assigned to the present assignee. The disclosures of these publications are specifically incorporated herein by reference.

In the present embodiment connections to the mic 102, or the component 701, or both, may be made by vias 702 fabricated in the microcap 104. The vias 702 include contacts 703 that connect to contact pads 704, which in turn connect to the mic 102, or the component 701, or both. Notably, details of the vias 701 and their fabrication may be found in the US patent Publication to Dungan, et al.

The vias 702 usefully reduce or eliminate the need for wirebonds or similar connections. As will be appreciated by one of ordinary skill in the art, wirebonds can be susceptible to electrical interference, which can be deleterious to the performance of the electrical components of the mic structure 700. Furthermore, wirebonding can be labor-intensive, which can adversely impact the final cost of the structure 700.

With the vias 702 making connections to the mic 102 and component 701, flip-chip mounting of the structure 700 is contemplated as an optional connection scheme. Notably, a top surface 705 of the microcap 104 is disposed over a substrate (not shown) and connected to contact pads thereon. In an embodiment, acoustic waves are incident on the mic 102 via the cavity 305. Pressure equalization may be provided in an opening (not shown) in the substrate 101, or in the gasket 105, or in the mic 102, or by providing a cantilevered mic structure as noted above.

FIG. 7B is a cross-sectional view of a mic structure 706 in accordance with a representative embodiment. Many of the details of mic structure 706 are common with those described in connection with the representative embodiments of FIGS. 1-7A and are not repeated so as to avoid obscuring the description of the present embodiment.

The mic structure 706 includes at least one via 709 through the substrate 101 and connecting to a contact pad 708. The contact pad 708 makes connections to, for example, electrodes (not shown) of the mic 102. As will be appreciated, the via 709 allows for the mounting a side 707 of the mic structure 706 to a substrate (not shown) and facilitates electrical connections thereto without wirebonds. This doesn't preclude wirebonding, but only offers another, potentially better, bonding alternative, right?

Notably, the component 701 may be included as shown in FIG. 7A. Moreover, the microcap 104 may include circuitry as described previously. Furthermore, the microcap 104 to may be made with vias such as vias 702 to make connections to contact pads on the substrate 101 and ultimately to connections on the substrate over which the substrate 101 is disposed. Such connections may be made through the via 709.

In connection with illustrative embodiments, piezoelectric microphones and methods of packaging the microphones are described. One of ordinary skill in the art appreciates that many variations that are in accordance with the present teachings are possible and remain within the scope of the appended claims. These and other variations would become clear to one of ordinary skill in the art after inspection of the specification, drawings and claims herein. The invention therefore is not to be restricted except within the spirit and scope of the appended claims.

1. A transducer structure, comprising:
a substrate having an upper surface and a lower surface;
a transducer disposed over the upper surface and over a cavity in the substrate;
a microcap structure having a gasket, which contacts the upper surface of the substrate; and
an opening adapted to provide ambient pressure equalization, or directional acoustic reception or transmission to the transducer.

2. A transducer structure as claimed in claim 1, further comprising a component disposed over the substrate, wherein the component includes electrical circuitry.

3. A transducer structure as claimed in claim 1, wherein the opening is provided through the microcap.

4. A transducer structure as claimed in claim 1, wherein the opening is provided through the gasket.

5. A transducer structure as claimed in claim 1, wherein the opening is provided in the transducer.

6. A transducer structure as claimed in claim 1, further comprising a via adapted to provide electrical connectivity to the transducer structure.

7. A transducer structure as claimed in claim 6, wherein the via is disposed in the microcap.

8. A transducer structure as claimed in claim 6, wherein the via is disposed in the substrate.

9. A transducer structure as claimed in claim 1, wherein the microcap further comprises electrical circuitry.

10. A transducer structure as claimed in claim 6, wherein the structure is flip-chip mounted over another substrate.

11. A transducer structure as claimed in claim 1, wherein the transducer is a microphone.

12. A transducer structure as claimed in claim 3, wherein the opening is offset relative to the transducer.

13. A transducer structure as claimed in claim 1, wherein the transducer is a piezoelectric transducer.

14. A transducer structure as claimed in claim 1, wherein the transducer is a capacitive transducer.

15. A method of fabricating a transducer, the method comprising:
providing a substrate;
etching a cavity in the substrate;
disposing a transducer over the cavity;
providing a microcap over the substrate; and
forming an opening adapted to provide ambient pressure equalization, or directional acoustic reception or transmission to the transducer.

16. A method as claimed in claim 15, wherein the forming the opening further comprises etching the microcap.

17. A method as claimed in claim 15, wherein the forming the opening further comprises forming the opening in a gasket in the microcap.

18. A method as claimed in claim 15, wherein the forming the opening further comprises forming an opening in the transducer.

19. A method as claimed in claim 15, further comprising:
forming vias in the microcap, wherein the vias are electrically connected to contact pads disposed over an upper surface of the substrate.

20. A method as claimed in claim 15, wherein the microcap further comprises electrical circuitry.

21. A method as claimed in claim 19, further comprising flip-chip bonding the microcap to another substrate.
